(19) United States
(12) Patent Application Publication
(10) Pub. No.: US 2015/0218665 A1
(43) Pub. Date: Aug. 6, 2015

(54) SOFTENING PROCESS AND SYSTEM FOR ROLL GOODS

(71) Applicants: Karl Rohr, Windsor (CA); Donald Vesey, Oakland, MI (US); Nathan Mullinix, Rochester, MI (US)

(72) Inventors: Karl Rohr, Windsor (CA); Donald Vesey, Oakland, MI (US); Nathan Mullinix, Rochester, MI (US)

(21) Appl. No.: 14/428,915

(22) PCT Filed: Sep. 19, 2013
(86) PCT No.: PCT/US13/60648

§ 371 Date: Mar. 17, 2015

Related U.S. Application Data
(60) Provisional application No. 61/704,246, filed on Sep. 21, 2012.

(51) Int. Cl. C14B 1/40

(52) U.S. Cl. CPC C14B 1/40

(57) ABSTRACT

A method and system for softening a high-density leather finished roll good and other stiff high density roll goods may include adjusting a first horizontal distance between a first impact grid and a first tunnel opening and adjusting a second horizontal distance between a second impact grid and a second tunnel opening based on the stiffness of the roll good. The method also may include introducing the roll good in a first direction through the air tunnel until the roll good hits the second impact grid, and introducing the roll good in an opposite direction through the air tunnel until the roll good hits the first impact grid. The method may further include passing the roll good through a cooling chamber.

### CROSS REFERENCES TO RELATED APPLICATIONS

This application claims the benefit of the filing date of U.S. Provisional Patent Application No. 61/704,246 entitled “Softening Process and System for Roll Goods” filed Sep. 21, 2012, which is hereby incorporated by reference for all purposes as if set forth in its entirety herein.

### STATEMENT REGARDING FEDERALLY SPONSORED RESEARCH

Not Applicable.

### BACKGROUND OF INVENTION

Existing leather industry softening technologies for leather hides include staking machining and drum milling equipment. A staking machine makes leather softer and more flexible by massaging it to separate the leather's fibers. More specifically, the staking machine includes a pin wheel with a series of blunt pins (“staking pins”), as shown in FIG. 1, that pummel and flex the leather as it is passed through the machine, therefore softening the hide through mechanical manipulation. A milling drum machine, as shown in FIG. 2, is primarily used to soften leather during the milling process of semi-finished and finished materials. Milling is performed using “pins” or “shelves”, as shown in FIG. 3, attached to the inner walls of the milling drum to allow continuous impact of a batch-type load placed within the milling drum during a tumbling process. Air is continually exchanged during this tumbling process so that softening of the leather is based on both the mechanical action of the pins or shelves as well as the temperature and humidity within the milling drum.

New high-density leather-based substrates consisting of leather fibers in various mediums are being developed that cannot be softened using the above-described equipment. For example, these leather-based substrates consist of woven and non-woven synthetic substrates produced via one or more of needle punching, hydro-entangling, and thermo bonding processes with fabrics including various polymer fiber blends. These leather-based substrates can be produced as roll good products, but must be finished to achieve a softness in compliance with automotive interior requirements. This has proven difficult, however, as current industry softening technologies only focus on softening leather hides or lower density fabric roll materials.

The existing leather industry technology is not capable of softening leather-based roll good products due to the volume and length of material contained in a roll. More specifically, leather industry staking operations function on individual hides and are not compatible with roll good type materials. Similarly, leather industry milling operations function on a batch type process consisting of a set number of hides and are not compatible with roll good type materials. Utilization of such equipment with leather-based roll goods would therefore require cutting of specific lengths to accommodate the equipment designs and result in an ineffective roll good continuous process.

Existing softening systems in the textile finishing industry, for example for fabric roll materials, implement a combination of steaming, drying, and tumbling to improve fabric drape, softening, and shrinkage. Wet, dry, or steamed fabric is transported by high speed air flows, passing through an air duct or tunnel and eventually impacting against a steel barrier plate, board or grid, which yields the mechanical action necessary to improve overall softness and drape. Such systems work well for lower density materials because such materials allow high speed air flow transmission through those materials to enhance bulkiness and drying. However, due to the high-density nature of leather-based roll good substrates, these typical fabric industry methods cannot achieve adequate softening or provide the necessary aesthetic and mechanical properties that are required within the automotive industry. Issues like insufficient softness levels, surface marring, core fiber read through, grain definition loss, and loss of elongation properties are commonly observed when attempting to soften leather-based roll good substrates using these conventional methods and equipment.

Therefore, a need exists for a system and method for softening leather-based roll goods that overcome the above-identified inefficiencies of current industry standards.

### SUMMARY OF THE INVENTION

The present invention provides a method of softening a roll good. The method employs a system with a first tunnel opening, an air tunnel, a second tunnel opening, a first impact grid adjacent the first tunnel opening, and a second impact grid adjacent to the second tunnel opening. A first horizontal distance between the first impact grid and the first tunnel opening is adjusted based on a stiffness of the roll good and a second horizontal distance between the second impact grid and the second tunnel opening is adjusted based on the stiffness of the roll good. The roll good is introduced in a first direction through the air tunnel from the first tunnel opening to the second tunnel opening until the roll good hits the second impact grid and folds over itself. Then, the roll good is introduced in a second, opposite direction through the air tunnel from the second tunnel opening to the first tunnel opening until the roll good hits the first impact grid.

The method may be adapted to better soften high-density leather finished roll goods or other high density roll goods. Such high density roll goods are difficult to soften using conventional methods.

In some forms of this method, the roll good may be passed through a cooling chamber, a moisture level of the roll good may be sensed, and at least one parameter of the system for softening the roll good may be adjusted if the sensed moisture level is unequal to a desired moisture level. The parameter or parameters may include one or more of exhaust air percentage, make up air percentage, and a speed of an air flow. Passing the roll good through the cooling chamber may include applying cooled air to the roll good.

In some forms of this method, the method may further include adjusting a cross sectional area of at least one of the first tunnel opening and the second tunnel opening.

In some forms of this method, the system may include a first tunnel opening roller adjacent the first tunnel opening and a second tunnel opening roller adjacent the second tunnel opening. The first tunnel opening roller may be shifted downward and the second tunnel opening roller may be shifted upward when the roll good passes through the tunnel from the second tunnel opening to the first tunnel opening.

In some forms of this method, the steps of introducing the roll good in the first direction and of introducing the roll good in the second direction are repeated until the roll good achieves a desired softness.

The present invention also provides a tumbler system for softening roll goods. The system includes an air tunnel with a first tunnel opening and a second tunnel opening and a controller. The controller controls a speed and a direction of an air flow through the air tunnel and controls a cross sectional area of at least one of the first tunnel opening and the second tunnel opening to direct the roll goods through the air tunnel in a first direction from the first tunnel opening to the second tunnel opening and in a second direction from the second tunnel opening to the first tunnel opening.

In some forms of this tumbler system, the system may further include a first dynamic roller positioned adjacent to the first tunnel opening and a second dynamic roller positioned adjacent to the second tunnel opening. The controller may be configured to shift the first dynamic roller upward and the second dynamic roller downward when directing the roll goods (such as, for example, high-density leather finished roll goods or other high density roll goods) through the air tunnel in the first direction. The controller may be further configured to shift the first dynamic roller downward and the second dynamic roller upward when directing the roll goods through the air tunnel in the second direction.

Another tumbler system for roll goods according to the present invention includes an air tunnel with a first tunnel opening and a second tunnel opening. The system further includes a controller controlling a speed and a direction of an air flow through the air tunnel to direct roll goods through the air tunnel in a first direction and a second direction. The system also includes a first impact grid positioned adjacent to the first tunnel opening and a second impact grid positioned adjacent to the second tunnel opening.

Again, the controller may adjust a first horizontal distance between the first impact grid and the first tunnel opening and a second horizontal distance between the second impact grid and the second tunnel opening based on a stiffness of the high-density leather finished roll goods.

Yet another tumbler system according to the present invention includes an air tunnel with a first tunnel opening and a second tunnel opening and a controller controlling a speed and a direction of an air flow through the air tunnel to direct a roll good material through the air tunnel in a first direction and a second direction. The tumbler system also includes a cooling system applying cooled air to the roll good material after the roll good material exits the air tunnel.

Again, the roll good material may be a high-density finished roll good material. The cooling system may apply cooled air to the high-density finished roll good material before the high-density finished roll good material is wound or folded, or both.

Another tumbler system according to the present invention includes an air tunnel with a first tunnel opening and a second tunnel opening and at least one controller controlling a speed and a direction of an air flow through the air tunnel to direct the roll goods through the air tunnel in a first direction and a second direction. The system also includes at least one moisture sensor positioned adjacent to at least one of the first tunnel opening and the second tunnel opening and in communication with the controller or controllers. The moisture sensor or sensors senses a moisture level of the roll goods and communicates the sensed moisture level to the controller or controllers. The controller or controllers compares the sensed moisture level to a desired moisture level and adjusts at least one system variable based on the comparison.

In some forms of this system, system parameter or parameters may include one or more of exhaust air percentage, make up air percentage, and the speed of the air flow.

In some forms of this system, the controller or controllers includes a programmable logic controller

In some forms of this system, the controller or controllers adjust the system parameter or parameters based on the comparison to maintain the sensed moisture level equal to the desired moisture level.

According to still another method in accordance with the present invention, a method of softening a roll good using a system for softening the roll good, the system including a first tunnel opening, an air tunnel, and a second tunnel opening is disclosed. The method includes adjusting a cross sectional area of at least one of the first tunnel opening and the second tunnel opening, such that the cross sectional area of the first tunnel opening is smaller than the cross sectional area of the second tunnel opening and passing the roll goods through the air tunnel from the first tunnel opening to the second tunnel opening.

In some forms of the method, the system may further include a first tunnel opening roller adjacent the first tunnel opening and a second tunnel opening roller adjacent the second tunnel opening. Then, the method may further include a step of shifting the first tunnel opening roller downward and the second tunnel opening roller upward when the roll good passes through the tunnel from the second tunnel opening to the first tunnel opening.

In some forms of the method, the method may further include readjusting the cross sectional area of at least one of the first tunnel opening and the second tunnel opening, such that the cross sectional area of the first tunnel opening is larger than the cross sectional area of the second tunnel opening. Then, the roll goods may be passed through the air tunnel from the second tunnel opening to the first tunnel opening.

The foregoing and other objects and advantages of the invention will appear from the following detailed description. In the description, reference is made to the accompanying drawings which illustrate a preferred embodiment of the invention.

### BRIEF DESCRIPTION OF THE DRAWINGS

FIG. 1 is a diagrammatic view of staking pins used within a staking machine of a staking machine process.

FIG. 2 is perspective view of a drum milling machine.

FIG. 3 is another perspective view of the drum milling machine of FIG. 2.

FIG. 4 is a perspective view of a continuous tumbler system for use with the present invention.

FIG. 5 is a schematic view of an air tunnel of a continuous tumbler system including dynamically tuned rollers, in accordance with the present invention.

FIG. 6 is a partial schematic view of an air tunnel of a continuous tumbler system including an adjustable impact grid, in accordance with the present invention.

FIG. 7 is a schematic view of an air tunnel of a conventional continuous tumbler system including fixed rollers.

FIG. 8 is a schematic view of a conventional continuous tumbler system including an ambient air fan.

FIG. 9 is a schematic view of a continuous tumbler system with a moisture management system, in accordance with the present invention.

FIG. 10 is a flow chart of a high-density leather finished roll good softening process according to one embodiment of the present invention.

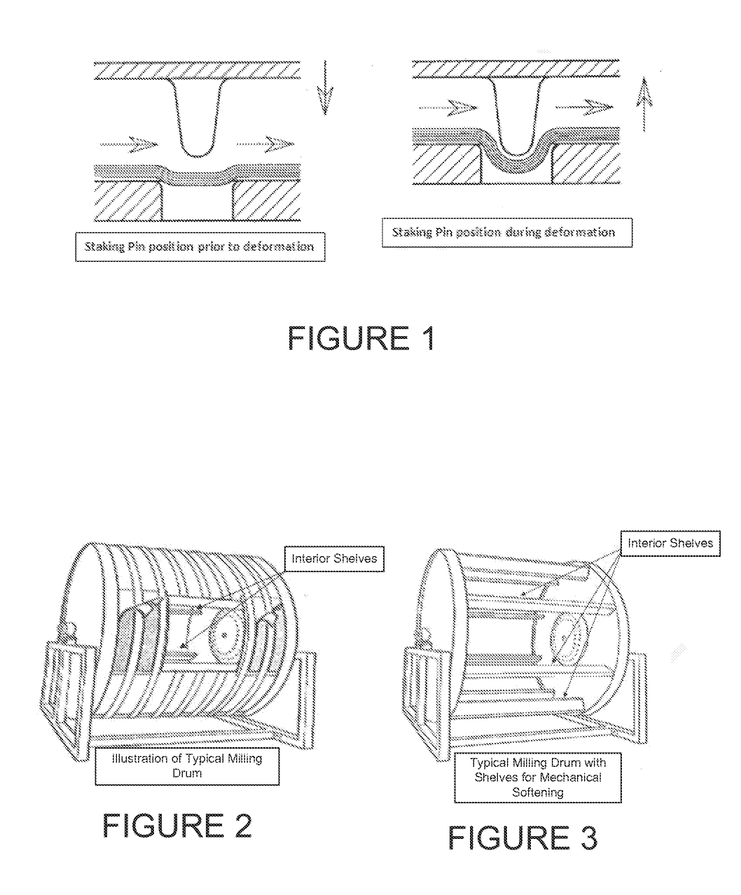

### DETAILED DESCRIPTION OF THE INVENTION

The present invention provides a system and method for softening high-density leather finished roll goods. The system achieves enhanced softness of high-density leather finished roll goods, in comparison to conventional textile softening systems, by implementing air flow adjustments, reduced tunnel entry friction, adjustable impact grids, moisture management, and cooling systems, as further described below.

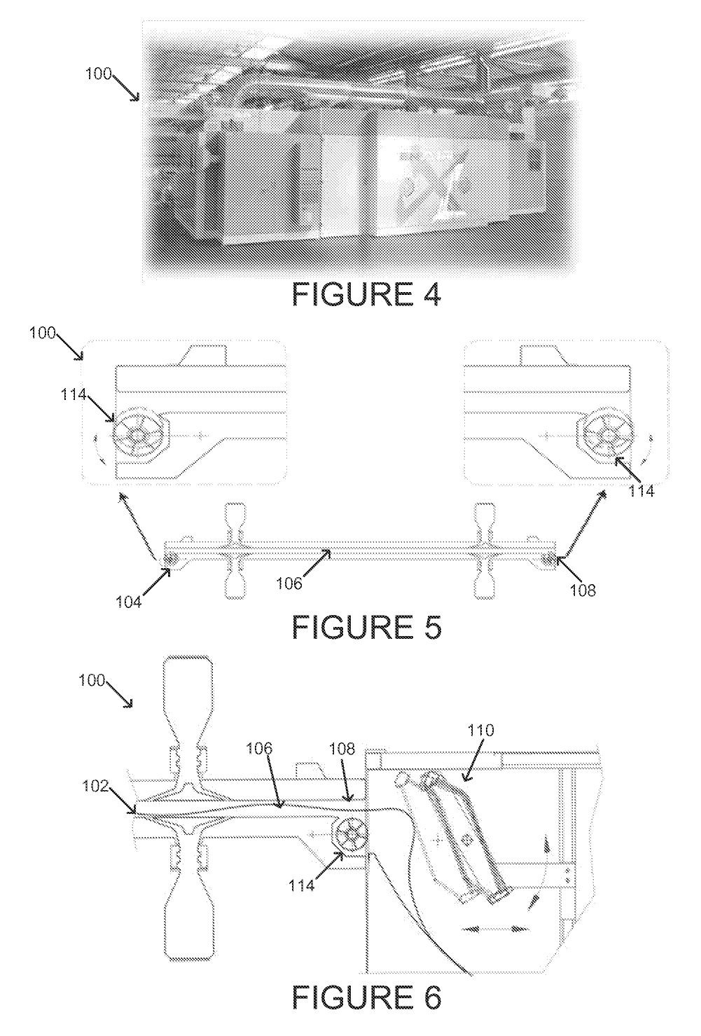

FIG. 4 illustrates a continuous tumbler system 100 according to the present invention. The continuous tumbler system 100 is substantially similar to a state of the art textile process system, such as the ENAIRGY XL, manufactured by Pentek Textile Machinery SRL, of Prato, Italy, where a material is transported through the system 100 by directed high speed air flows. More specifically, as shown in FIGS. 5 and 6, the directed high speed air flows move a roll good 102, such as a leather substrate material, from a first tunnel opening, or entry 104, through an air tunnel 106, and out a second tunnel opening, or exit 108. Once out the tunnel exit 108, the material 102 hits an impact grid 110 and folds over itself until air flow redirects the material 102 in an opposite direction, passing the material 102 from the tunnel exit 108, through the air tunnel 106 and out the tunnel entry 104, where the material 102 again hits an impact grid 110 and folds over itself. Although not illustrated an impact grid 110 is also present adjacent the tunnel entry 104 is a manner that generally mirrors what is illustrated in FIG. 6. The material 102 is softened through the mechanical action of hitting the impact grid 110. This process is repeated a desired number of times until the material 102 is adequately softened, and then the material 102 is directed out of the system 100 to be wound and folded.

Conventional systems, such as the Pentek ENAIRGY XL described above, are designed for sufficiently softening textile materials, but cannot adequately soften high-density leather roll goods due to the different properties of such materials. The present system 100, however, includes a number of different features that enables its use for sufficiently softening high-density leather roll goods, for example to achieve a softness required to enable use of the material in automotive interiors. Generally, these features include increased air flow pressure, reduced tunnel entry friction, adjustable impact grids, moisture management, and cooling.

With respect to air flow pressure, an increase in air flow pressure provides the system 100 with the ability to transport higher density leather substrate material 102 while obtaining the desired balance of material transport and softening effect. For example, current textile fabrics used within existing softening systems are characterized by increased surface area and pliability, in comparison to higher density, non-permeable, stiffer leather materials. Due to the increased surface areas of the more pliable textile fabrics, lower air pressures are able to make greater surface contact and thrust the materials forward with greater velocity, therefore achieving greater mechanical action at impact grids. In contrast, higher air flow pressures applied to the higher density leather substrate material 102 will result in better movement of the leather substrate material 102 and, as a result, greater mechanical action at the impact grids 110.

These higher pressures are achieved in a preferred embodiment by increasing a motor speed of an air supply fan within the system (not shown) from its conventional speed of about 2800 rotations per minute (rpm) used for typical textiles to about 3100 rpm, and by increasing power to the fan motor from about 55 kiloWatts (kW) to about 75 kW. The motor speed and power changes elicit an air velocity increase of up to about 40% and an air volume increase of up to about 30%, over conventional industry conditions, through the air tunnel 106 of the system 100. These increases result in an increased acceleration of the leather substrate material 102 as it passes through the air tunnel 106, which helps attain softening of the leather substrate material 102 in compliance with automotive interior requirements.

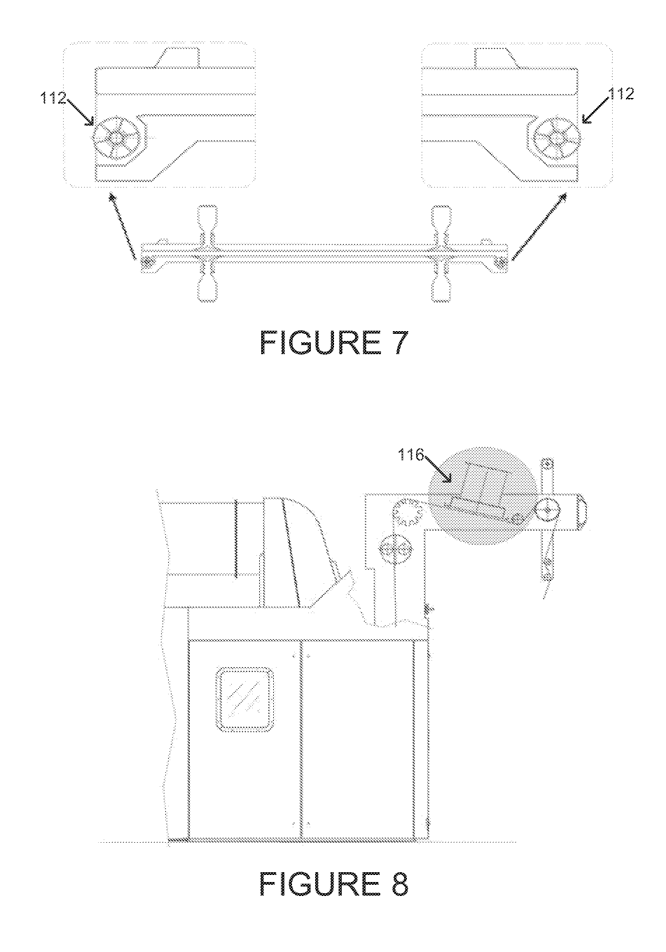

The speed at which leather substrate material 102 enters and exits the above-described air tunnel 106 is greatly affected by sizes of the tunnel openings (that is, the cross sectional area of the tunnel entry 104 and tunnel exit 108). For example, as shown in FIG. 7, conventional systems utilize a fixed idle roller 112 at both the tunnel entry 104 and tunnel exit 108 to assist with material transport. Although fixed idle rollers 112 are effective for lower density, more pliable textile materials, they do not yield the same results with stiffer leather substrate material 102. Specifically, during transport of leather substrate material 102, fixed idle rollers 112 cause a material speed reduction at both the tunnel entry 104 and the tunnel exit 108.

To overcome these speed reductions, the present system 100 includes dynamically tuned rollers 114, as shown in FIG. 5, at the tunnel entry 104 and the tunnel exit 108 to adjust the size of the tunnel entry 104 and tunnel exit 108 and accommodate the less pliable, stiffer leather substrate material 102. These dynamically tuned rollers 114, which can rotate and move up and down, reduce friction, minimize contact between the moving leather substrate material 102 and air duct surfaces, and increase the overall velocity of the leather substrate material 102 as it passes through the air tunnel 106.

The dynamically tuned rollers 114 are raised or lowered to ensure the leather enters the tunnel through an opening having a smaller cross sectional area than the opening through which the leather exits the tunnel. To accomplish this, during operation, the entry side roller 114 is shifted up, therefore narrowing the first tunnel opening, i.e. reducing the cross sectional area of the tunnel entry 104, while the exit side roller 114 is shifted down to open up the second tunnel opening (that is, increase the cross sectional area of the tunnel exit 108). This results in the path of least resistance for the air introduced into the tunnel 106 by the air supply fan being forced through the tunnel exit 108, allowing more fluid movement of the leather substrate material 102 as it passes through the air tunnel 106 and out the tunnel exit 108. This same condition is achieved in the reverse order (that is, exit side roller 114 up, entry side roller 114 down) as the accumulated rolled leather substrate material 102 is moved backward through the air tunnel 106, from tunnel exit 108 to tunnel entry 104, when air stream directions of the system 100 are reversed. Although adjusting the cross sectional area of both the tunnel entry 104 and tunnel exit 108 is disclosed, the cross sectional area of only one of the tunnel entry 104 and tunnel exit 108 could be adjusted such that the cross sectional area of the tunnel entry 104 has a smaller cross sectional area than the tunnel exit 108 when the leather passes through the tunnel 106 from the tunnel entry 104 to the tunnel exit 108 and the tunnel entry 104 has a larger cross sectional area than the tunnel exit 108 when the leather passes through the tunnel 106 from the tunnel exit 108 to the tunnel entry 104 without departing from the scope of the invention.

As material 102 passes through the air tunnel 106 (that is, from tunnel entry 104 to tunnel exit 108 or from tunnel exit 108 to tunnel entry 104), it is received by the impact grid 110 and folds over itself until it is passed back through the air tunnel 106. Conventional system designs include fixed impact grids 110 positioned at each end of the air tunnel 106 or, in other words, permanently set a fixed distance from the tunnel entry 104 and the tunnel exit 108, to allow ample air flow passage and achieve adequate softening of the textile materials. These fixed distances are effective for more pliable textile materials, which fold over at a substantially high rate. However, less pliable leather substrate material 102 cannot fold over at such high rates and therefore are unable to achieve the same level of softening as textile materials on the fixed impact grids 110.

In order to achieve a wider range of softening performance, the present system 100 includes adjustable impact grids 110, as shown in FIG. 6, where the distance and area between the tunnel exit 108 and the tunnel entry 106 and their respective impact grid 110 are adjustable to accommodate the less pliable leather substrate material 102. More specifically, the system impact grids 110 are adjustable along a horizontal plane to accommodate varying stiffness levels in substrate leather substrate materials 102, therefore allowing the leather substrate materials 102 to be processed more efficiently in order to achieve required softness properties in compliance with automotive industry requirements.

As described above, after a sufficient number of iterations through the air tunnel 106 to impact the grids 110, materials 102 exiting the system 100 are wound and/or folded. As shown in FIG. 8, conventional systems include an ambient air fan 116 to help cool the exiting textile material, but have no way of determining the moisture of the exiting material. Currently, a machine operator must manually monitor moisture output and attempt to adjust system parameters in order to achieve a desired moisture output and ensure end product consistency. As systems are located in various global locations with different moisture levels, such manual operations may be very different across locations.

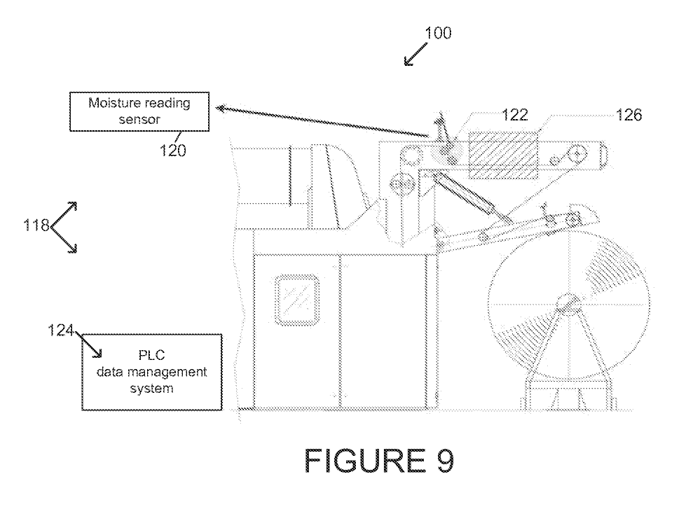

The present system 100 provides a moisture management control system 118, as shown in FIG. 9, to automatically manage moisture levels of exiting material 102, thereby ensuring end product consistencies regardless of global production location. The moisture management control system 118 is implemented by moisture sensors 120 (for example, located at a system exit point 122) in communication with an equipment programmable logic controller (PLC) 124 that monitors sensed moisture of the exiting material 102. Based on sensed moisture levels communicated from the moisture sensors 120, or more specifically based on a comparison of the sensed moisture levels and a desired moisture level, the PLC 124 automatically makes adjustments to other system parameters or processes, such as make up air percentage, exhaust air percentage and working speed of the substrate material 102 through the tunnel 106, to achieve a consistent desired moisture output.

As described above, conventional systems utilize an ambient air fan 116 for cooling exiting textile material prior to winding and/or folding. While an ambient air fan 116 functions adequately for textile materials, leather materials 102 processed under these conditions can exhibit loss of grain retention and adhesion of their finished surfaces if rolled at excessive temperatures. For example, exit temperatures of leather substrate material 102 can reach up to about 110 degrees Celsius. Ambient air flow across such warm materials 102 cannot cool them enough to prevent the above undesirable issues. To eliminate the risk of such issues occurring, the present system 100 provides a cooling chamber and chiller system 126, as shown in FIG. 9, to more effectively reduce material temperature in the short time span before final winding. The cooling chamber and chiller system 126, by provision of cooled air instead of ambient air, is capable of reducing material temperatures up to about 30% from their exit point temperature to achieve a high level of grain retention upon rolling of the leather substrate material 102.

In light of the above, the present system provides 100 a number of design changes over existing textile tumbler systems to accommodate sufficient softening of high-density leather roll goods. By incorporating high air velocities and volumes, the resulting increased air flow pressure improves material transportation and levitation of the higher density leather roll substrate, in comparison to lower air flows of conventional systems. By incorporating tuned “auto dynamic” rollers 114 designed to raise and lower air tunnel entry and exit points, higher material speeds through the air tunnel 106 are achieved and surface defects generated from contact with entry and exit points are eliminated. By incorporating impact grids 110 that are adjusted based on the stiffness of the leather material 102, desired material softening is achievable over a wide range of substrate density and finishes. By incorporating a moisture management control system 118, consistent material exit moisture levels are achieved, enabling global transparency of equipment moisture capabilities and accommodating research and development efforts with respect to material moisture levels. Finally, by incorporating a cooling chamber and chiller system 126, material exit temperature is reduced by up to 30% upon winding, thereby maintaining grain definition and eliminating adhesion of material finishes after rolling. These features are implemented in the system 100 (for example, horizontal adjustment of the impact grids 110, shifting of the dynamic rollers 114, controlling speed and direction of the directed high speed air flows, etc.) by the PLC 124 or another controller of the system 100.

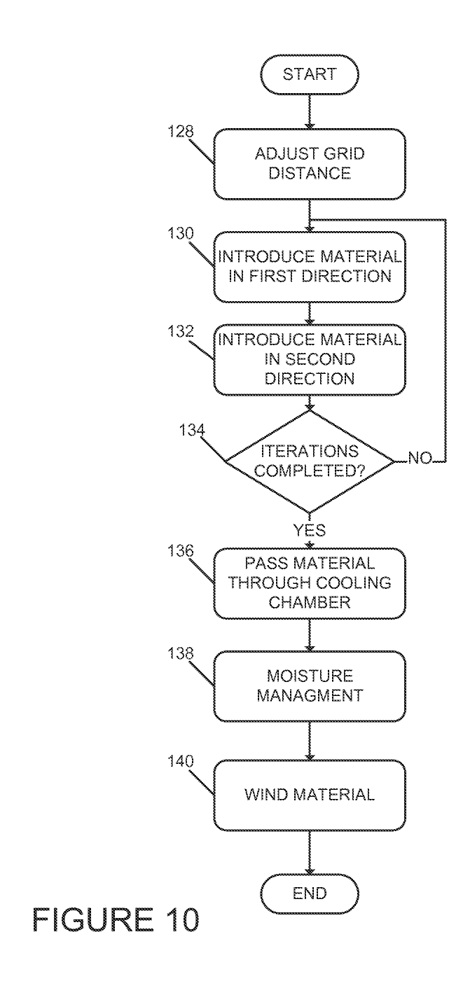

Accordingly, a method for use with the present invention is shown in FIG. 10. The method includes adjusting a horizontal distance between a tunnel entry and its adjacent impact grid and a tunnel exit and its adjacent impact grid based on a stiffness of a leather roll good material (step 128) and introducing the material in a first direction through an air tunnel from tunnel entry to tunnel exit until the material hits an impact grid and folds over itself (step 130). This step further includes reducing the tunnel entry area by shifting a tunnel entry roller upward and a tunnel exit roller downward. Next, the material is introduced in a second, opposite direction through the air tunnel from tunnel exit to tunnel entry until the material hits another impact grid and folds over itself (step 132). This step further includes shifting a tunnel entry roller downward and a tunnel exit roller upward. Although adjusting the height of the rollers 114, at the tunnel entry 104 and tunnel exit 108 is preferred, other methods of adjusting the cross sectional areas of the tunnel entry 104 and tunnel exit 108, such as by using adjustment plates or baffles at the tunnel entry and exit or pivoting the tunnel walls about central pivot points, can be used without departing from the scope of the invention. Steps 130 and 132 are then repeated for a desired number of iterations. When the desired number of iterations have been completed, as determined at step 134, the material exits the system and is passed through a cooling chamber and chilling system (step 136). Also upon exiting the system or prior to passing through the cooling chamber, a moisture management system senses a moisture level of the material and makes system adjustments if the sensed moisture level is not at a desired moisture level (step 138). Once passed through a cooling chamber and chilling system, the material is then wound and/or folded (step 140).

While there has been shown and described what are at present considered the preferred embodiments of the invention, it will be obvious to those skilled in the art that various changes and modifications can be made therein without departing from the scope of the invention defined by the appended claims. For example, the method and apparatus disclosed herein is not limited to leather goods and can be used to soften any stiff high density roll goods having a heavy density and a low pliability compared to roll goods currently softened using state of the art textile process systems.

I claim:

1. A method of softening a roll good using a system for softening the roll good, the system including a first tunnel opening, an air tunnel, a second tunnel opening, a first impact grid adjacent the first tunnel opening, and a second impact grid adjacent to the second tunnel opening, the method comprising:
adjusting a first horizontal distance between the first impact grid and the first tunnel opening based on a stiffness of the roll good;
adjusting a second horizontal distance between the second impact grid and the second tunnel opening based on the stiffness of the roll good;
introducing the roll good in a first direction through the air tunnel from the first tunnel opening to the second tunnel opening until the roll good hits the second impact grid and folds over itself; and
introducing the roll good in a second, opposite direction through the air tunnel from the second tunnel opening to the second tunnel opening until the roll good hits the first impact grid.

2. The method as in claim 1, further comprising the step of passing the roll good through a cooling chamber, sensing a moisture level of the roll good, and adjusting at least one parameter of the system for softening the roll good if the sensed moisture level is unequal to a desired moisture level.

3. The method as in claim 2, wherein the at least one parameter includes one of exhaust air percentage, make up air percentage, and a speed of an air flow.

4. The method as in claim 2, in which the step of passing the roll good through the cooling chamber includes applying cooled air to the roll good which is a high-density leather finished roll good.

5. The method as in claim 1, including the step of adjusting a cross sectional area of at least one of the first tunnel opening and the second tunnel opening.

6. The method as in claim 1, in which the system includes a first tunnel opening roller adjacent the first tunnel opening and a second tunnel opening roller adjacent the second tunnel opening, and the method includes a step of shifting the first tunnel opening roller downward and the second tunnel opening roller upward when the roll good passes through the tunnel from the second tunnel opening to the first tunnel opening.

7. The method as in claim 1, in which the step of introducing the roll good in the first direction and the step of introducing the roll good in the second direction are repeated until the roll good achieves a desired softness.

8. A tumbler system for softening roll goods, the tumbler system comprising:
an air tunnel with a first tunnel opening and a second tunnel opening;
a controller controlling a speed and a direction of an air flow through the air tunnel and controlling a cross sectional area of at least one of the first tunnel opening and the second tunnel opening to direct the roll goods through the air tunnel in a first direction from the first tunnel opening to the second tunnel opening and in a second direction from the second tunnel opening to the first tunnel opening.

9. The tumbler system of claim 8, further comprising:
a first dynamic roller positioned adjacent to the first tunnel opening; and
a second dynamic roller positioned adjacent to the second tunnel opening;
wherein the roll goods are a high-density leather finished roll goods and wherein the controller is configured to shift the first dynamic roller upward and the second dynamic roller downward when directing the high-density leather finished roll goods through the air tunnel in the first direction and is further configured to shift the first dynamic roller downward and the second dynamic roller upward when directing the high-density leather finished roll goods through the air tunnel in the second direction.

10. A tumbler system for roll goods, the tumbler system comprising:
an air tunnel with a first tunnel opening and a second tunnel opening;
a controller controlling a speed and a direction of an air flow through the air tunnel to direct the roll goods through the air tunnel in a first direction and a second direction;
a first impact grid positioned adjacent to the first tunnel opening, the controller adjusting a first horizontal distance between the first impact grid and the first tunnel opening; and
a second impact grid positioned adjacent to the second tunnel opening, the controller adjusting a second horizontal distance between the second impact grid and the second tunnel opening.

11. The tumbler system of claim 10, wherein the roll goods are high-density leather finished roll goods and wherein the controller adjusts at least one of the first horizontal distance and the second horizontal distance based on a stiffness of the high-density leather finished roll goods.

12. A tumbler system for softening a roll good material, the tumbler system comprising:
an air tunnel with a first tunnel opening and a second tunnel opening;
a controller controlling a speed and a direction of an air flow through the air tunnel to direct the roll good material through the air tunnel in a first direction and a second direction; and
a cooling system applying cooled air to the roll good material after roll good material exits the air tunnel.

13. The tumbler system of claim 12, wherein the roll good material is a high-density finished roll good material and wherein the cooling system applies cooled air to the high-density finished roll good material before the high-density finished roll good material is at least one of wound and folded.

14. A tumbler system for softening roll goods, the tumbler system comprising:
an air tunnel with a first tunnel opening and a second tunnel opening;
at least one controller controlling a speed and a direction of an air flow through the air tunnel to direct the roll goods through the air tunnel in a first direction and a second direction; and
at least one moisture sensor positioned adjacent to at least one of the first tunnel opening and the second tunnel opening and in communication with the at least one controller, the at least one moisture sensor sensing a moisture level of the roll goods and communicating the sensed moisture level to the at least one controller, the at least one controller comparing the sensed moisture level to a desired moisture level and adjusting at least one system parameter based on the comparison.

15. The tumbler system of claim 14, wherein the at least one system parameter includes one of exhaust air percentage, make up air percentage, and the speed of the air flow.

16. The tumbler system of claim 14, wherein the at least one controller includes a programmable logic controller.

17. The tumbler system of claim 14, wherein the at least one controller adjusts at least one system parameter based on the comparison to maintain the sensed moisture level equal to the desired moisture level.

18. A method of softening a roll good using a system for softening the roll good, the system including a first tunnel opening, an air tunnel, and a second tunnel opening, the method comprising:
adjusting a cross sectional area of at least one of the first tunnel opening and the second tunnel opening, such that the cross sectional area of the first tunnel opening is smaller than the cross sectional area of the second tunnel opening; and
passing roll goods through the air tunnel from the first tunnel opening to the second tunnel opening.

19. The method as in claim 18, wherein the system further includes a first tunnel opening roller adjacent the first tunnel opening and a second tunnel opening roller adjacent the second tunnel opening, and the method comprises a step of shifting the first tunnel opening roller downward and the second tunnel opening roller upward when the roll good passes through the tunnel from the second tunnel opening to the first tunnel opening.

20. The method as in claim 18, further comprising the steps of:
readjusting the cross sectional area of at least one of the first tunnel opening and the second tunnel opening, such that the cross sectional area of the first tunnel opening is larger than the cross sectional area of the second tunnel opening; and
passing roll goods through the air tunnel from the second tunnel opening to the first tunnel opening.
